(19) United States
(12) Patent Application Publication
(10) Pub. No.: US 2003/0088710 A1
(43) Pub. Date: May 8, 2003

(54) Simulation environment software

(76) Inventors: Sukhwinder Sandhu, Calgary (CA); Bertrand Michaud, Kanata (CA); Gregory Dick, Calgary (CA)

Correspondence Address: FAY KAPLUN & MARCIN, LLP, 15O BROADWAY, SUITE 702, NEW YORK, NY, 10038, US

(21) Appl. No.: 09/899,705

(22) Filed: Jul. 5, 2001

(51) Int. Cl. G06F 13/10

(52) U.S. Cl. 709/321

(57) ABSTRACT

A method for developing a device application for interacting with an outside application includes the steps of installing a first driver module being one of a first native driver to operate on the device and an emulation of the first native driver and installing a first interface module for managing communication between the first driver module and the outside application, wherein the first interface module is configured to operate with both the first native driver and the emulation of the first native driver in combination with the step of installing a driver locator module which, upon receipt of a communication from the outside application, locates one of a native driver to which the communication corresponds and an emulation thereof.

A software package for developing a device application for interacting with an outside application comprises a first driver module being one of a first native driver to operate on the device and an emulation of the first native driver and a first interface module for managing communication between the first driver module and the outside application, wherein the first interface module is configured to operate with both the first native driver and the emulation of the first native driver in combination with a driver locator module which, upon receipt of a communication from the outside application, locates one of a native driver to which the communication corresponds and an emulation thereof.

### BACKGROUND INFORMATION

The development of software for particular devices often entails extensive programming to add various software controlled functionalities. Large portions of this development are often device specific. Developers may be required to wait for the development of the target hardware which is to run the software before completing design of these device-specific components of the software.

### SUMMARY OF THE INVENTION

The present invention is directed to a method for developing a device application for interacting with an outside application including the steps of installing a first driver module being one of a first native driver to operate on the device and an emulation of the first native driver and installing a first interface module for managing communication between the first driver module and the outside application, wherein the first interface module is configured to operate with both the first native driver and the emulation of the first native driver in combination with the step of installing a driver locator module which, upon receipt of a communication from the outside application, locates one of a native driver to which the communication corresponds and an emulation thereof.

The present invention is further directed to a software package for developing a device application for interacting with an outside application comprising a first driver module being one of a first native driver to operate on the device and an emulation of the first native driver and a first interface module for managing communication between the first driver module and the outside application, wherein the first interface module is configured to operate with both the first native driver and the emulation of the first native driver in combination with a driver locator module which, upon receipt of a communication from the outside application, locates one of a native driver to which the communication corresponds and an emulation thereof.

### BRIEF DESCRIPTION OF DRAWINGS

FIG. 1A shows a system running a software development system according to an exemplary embodiment of the invention;

FIG. 1B shows the software development system of FIG. 1A;

FIG. 2 shows device software created using the software development system of FIG. 1; and

FIG. 3 is a block diagram showing the relationship between an emulated driver plug-in, a corresponding native driver and a common interface.

### DETAILED DESCRIPTION

The present invention may be further understood with reference to the following description of preferred exemplary embodiments and the related appended drawings, wherein like elements are provided with the same reference numerals. It is often desirable to have devices such as, e.g., personal digital assistants (“PDAs”) and other embedded computing environments interact with Java code. This allows, for example, the Java code to configure the hardware as in the case of an Ethernet connection or to perform input/output operations with the hardware. The applications described herein are illustrated in regard to use with the WindStorm™ software product available from Wind River Systems, Inc. of Alameda, Calif. Those skilled in the art will understand that there may be other devices which may require interaction with Java code or other code wherein the development process for creating software may be performed in a manner similar to that described herein in regard to the illustrative embodiment. Additionally, the software system according to the present invention may be employed to provide such solutions for interaction between any device and any separate programming code.

The present invention provides a flexible method for a software component to load a device driver that implements a specific interface regardless of whether the actual hardware or device driver is available. The driver may, for example, be an emulated object designed to perform on a particular host development platform or it may be an actual target platform specific file intended for use on the target hardware. Furthermore, the present invention allows software components to operate substantially identically whether operating with the actual target platform device driver or with an emulated driver and allows the software components to be decoupled from the actual loading of drivers. This in turn allows the software components to be developed via simulation before the actual drivers and/or the underlying hardware have been completed.

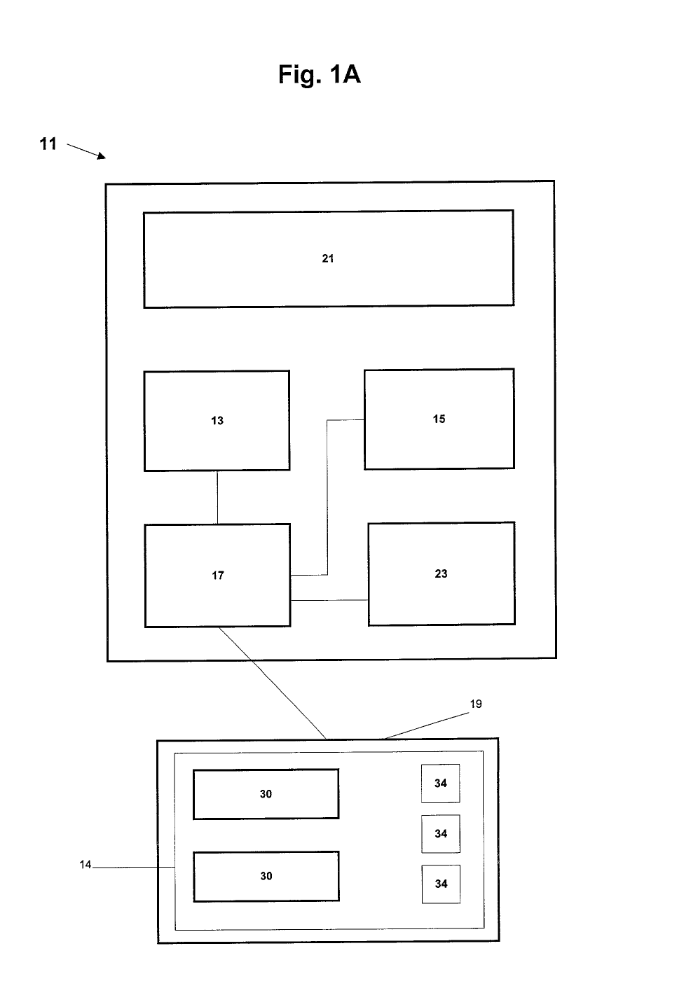

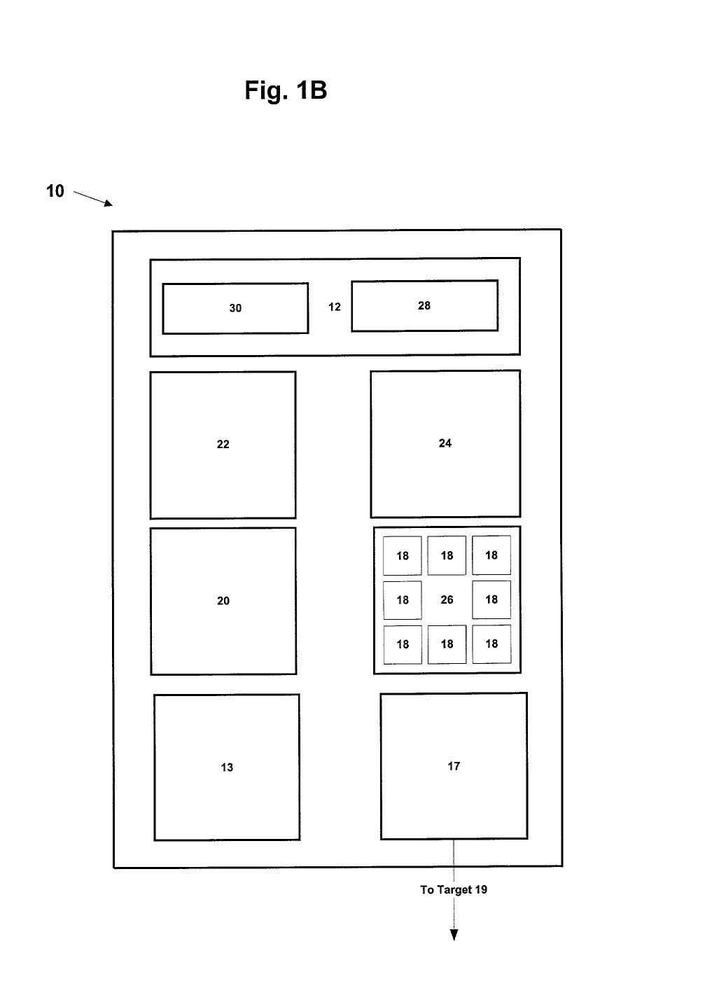

FIGS. 1A and 1B show a software development system 10 into which an exemplary simulation environment 12 according to the present invention may be incorporated. The software development system 10 may include, for example, a software solution directed to facilitating development of device software, for example, for devices requiring Java-based capabilities. Such capabilities may include, for example, remote monitoring and/or management of the target device and distributed processing. The software development system 10 may be operated on a host workstation 11 including, for example, development tools 13, an operating system simulator 15, a target agent 17 and a plurality of driver simulators 18′ along with the developed code 21. Those skilled in the art will understand that, in order to aid in development of the device operating environment 14, the development tools 13 may include, for example, a compiler, a debugger, a build tool, etc. The target agent 17 may facilitate communications between the host 11 and a target device 19 to which the software development system 10 may optionally be coupled during development. The target device 19 may include a device software system having, for example, an operating system 27, a Java virtual machine 29 and a plurality of device drivers 34. Those skilled in the art will understand that, when a target device 19 is not coupled to the host 11, the operating system simulator 15 may control operation of the host 11 to simulate the operation under the target device operating system 27. As further shown in FIG. 1B, the software development system 10 may also include a public library 20 content manager 22, a build tool 24 and a repository 26 in which a library of plug-ins 18 and other data may be stored for selection and use by the developer.

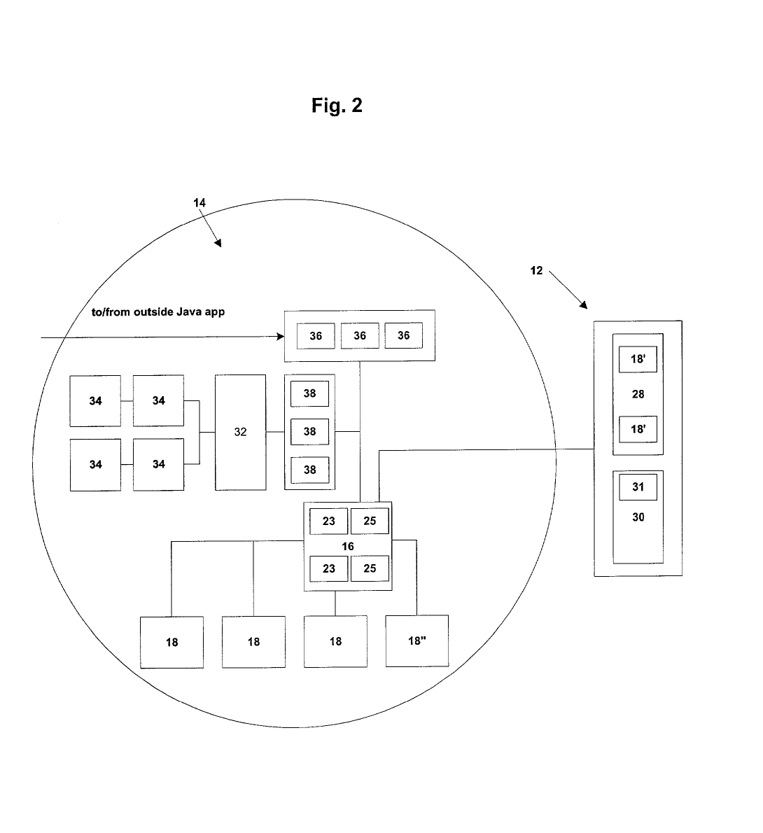

As shown in FIG. 2, the software development system 10 of FIGS. 1A and 1B, which may be generic and need not be adapted to a particular device or class of devices, may install into the device operating environment 14 a Java-based core module 16 to which a variety of plug-in applications 18 may be coupled. During development, all or a portion of the device operating environment 14 may reside on a developer's work station along with the simulation environment 12. Upon completion of the development process, all of the device operating environment 14 may be exported to the target device while the simulation environment remains on the work station. Where a portion of the device operating environment 14 resides on a target device during development, communications may be established between the work station and the target device via, for example, an Ethernet connection. The core module 16 may, for example, include one or more application programming interfaces (APIs) 23 as well as mechanisms 25 for managing plug-ins 18, the public library 20 of the software development system 10 of FIG. 1 and communications between plug-ins 18. The plug-ins 18, which may be selected by developers based on the needs of a particular implementation, include the concrete implementations of the services and applications that may be included in device operating environment 14 developed through the use of the software development system 10. The plug-ins 18 may provide a wide range of services, including, for example, simple timer services, fully functional web-browser functionality, etc. The developer simply selects the plug-ins 18 desired for the current application and adds them to the core module 16 to build the device operating environment 14.

The software development system 10 may further include a device simulation environment 12. The simulation environment 12 may be used to test applications from the initial stages of development through device integration and may begin simultaneously with or even before the development of the hardware for the target device. The simulation environment 12 allows developers to simulate the operation of the target device in conjunction with the Java-based applications developed for the target device and any Java Native Interface (JNI) interactions with an underlying operating system such as, for example, the WindRiver Vx Works® operating system available from WindRiver Systems.

Specifically, the simulation environment 12 includes a JNI simulation module 28 which may operate with a skin module 30 which may provide a plurality of graphical user interfaces (“GUIs”) for various aspects of the system under development. The software system 10 allows developers to apply a skin to a system under development in a way that allows each instance of the skin to provide a significantly different look while maintaining similar or identical functionality. Several classes are relevant to the skin module 30.

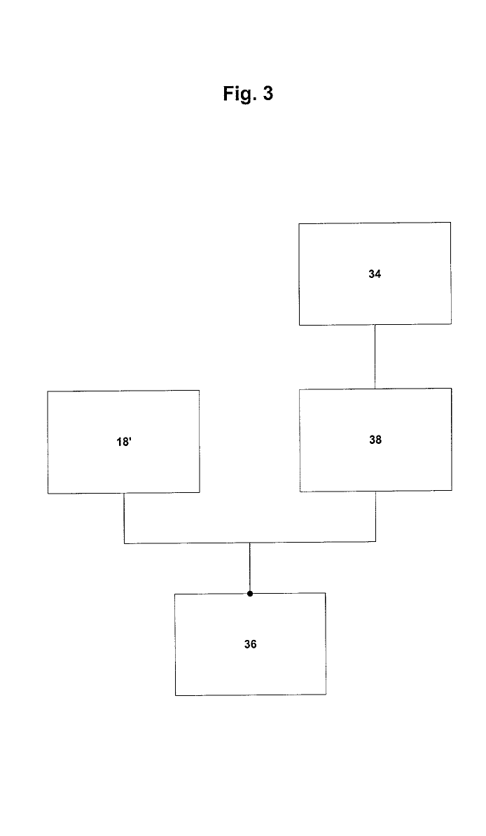

As shown in FIGS. 2 and 3, the target device operating environment 14 may include, in addition to the core module 16 and plug-in applications 18 incorporated therein, a JNI 32 which allows Java applications to interact with the native code in one or more native device drivers 34 included within the target device operating environment 14. The JNI simulation module 28 allows a developer to simulate on the host 11 interaction of the Java-based applications with the native device drivers 34 if, for example, the target hardware and/or native driver 34 is not yet available. The GUIs 31 within the skin module 30 provide a visual representation of the intended target device hardware, for example, on a display of the host 11. This allows developers to have test interaction with the functionality provided by the target hardware controls, buttons and/or indicators.

The JNI simulation module 28 is a collection of specially designed plug-ins 18′ running along side any available native drivers. The developer uses the software development system 10 to create two plug-ins for each of the native drivers 34 to be emulated. A first one of the plug-ins, 18′, includes a Java emulation of the corresponding native driver 34, while a second plug-in is a GUI 31 operating with the skin module 30. Unlike other plug-ins 18 which will become a permanent part of the device operating environment 14, emulated drivers 18′ and the GUIs 31 are stored outside the device operating environment 14 within the simulation module 28 and the skin module 30, respectively. As shown in FIGS. 2 and 3, the developer defines a plurality of driver interfaces 36 each of which is an API describing the specific functions of the corresponding driver. Each of the interfaces 36 is implemented by both an emulated driver 18′ and the JNI class

package com.windriver.ws.corex.cradle;
public interface CradleDriverInterface {

public boolean inCradle();
public void setInCradle(boolean p_bolInCradle);

}

The manifest file for the cradle service plug-in 18 may include, for example, the software code as follows:

<publicLibraryDescriptor name=“Cradle Service”

specification Version=″1.0>

<export>

<class>com.windriver.ws.corex.cradle.CradleDriverInterface</class>

</export>

<publicLibraryDescriptor>

Those skilled in the art will understand that a manifest file may alternatively be referred to as a configuration file, a definition file, etc. The manifest file contains information for the particular software program or function. When the program or function is executed, it consults the manifest file to determine the parameters which are in effect and the program and/or function is executed in accord with these parameters. The emulated driver 18′ is also an implementation of the interface 36. Therefore, an extension of the emulated driver 18′ is also a plug-in 18. The simulated cradle driver plug-in 18′ may include, for example, the software code as follows:

package com. windriver.ws.emulator.cradle;
import com.windriver.ws.corex.cradle.CradleDriverInterface;
import com.windriver.ws.emulator.controlmanger.EmulatedDriver;
/**
* An emulated version of the cradle driver
*/
public class EmulatedCradleDriver extends EmulatedDriver

implements CradleDriver Interface {

/**
* The control panel for this emulated driver
*/
private CradleControlPanel m_control;
/**
* State of the device (in cradle or not)
*/
private boolean m_bolInCradle;
/**
* Constructer.
*/
private EmulatedCradleDriver() {
}
/**
* Overriding the ServicePlugin method implemented in Emulated Driver.
* Sets in cradle status to false
*/
public void init () {

super.init();
m_bolInCradle = false;

}
/**
* Implementation of an abstract method found in EmulatedDriver. Allows a
* control panel to register itself
*/
public void setControlPanel (EmulatorControlPanel p_control) {
// keep ref to control panel, in case we need to send a state change
// to the GUI
m_control = (CradleControlPanel) p_control;

}
/**
* Implementation of CradleDriverInterface method - retrieves the state of
* the cradle
@ returns true if the device is in the cradle, else false
*/
public boolean inCradle () {
return m_bolInCradle;
}
/**
* Implementation of CradleDriverInterface method - sets the state of the cradle
@param p_bolInCradle Set the state of the cradle, true
* if the device is docked, otherwise false
*/
public void setInCradle (boolean p_bolInCradle) {
m_bolInCradle = p_inCradle;
}

}

The manifest file for the emulated cradle driver 18′ may then include the following lines:

<?xml version=“1.0” standalone = “no”?>
<!DOCTYPE definition SYSTEM “../../../config/dtd/definition.dtd”>
<!- - This is a definition file for the emualted Cradle JNI and control panel - ->
<definition>

<dependencies>

<project name=“windstorm”>

<archiveName> bootstrap </archiveName>
<archiveName> windstorm </archiveName>
<archiveName> cradle </archiveName>

</project>
<project name=“emulator”>

<archiveName> swing </archiveName>
<archiveName> controlmanager </archiveName>

</project>
</dependencies>

<archive name=“Cradle Emulator”>

<pluginDescriptor name=“Emulated Cradle Driver”

class=“com.windriver.ws.emulator.cradle.

EmulatedCradleDriver”

type=“SYSTEM”>

<pluginDescriptor>
<pluginDescriptor name=“Emulated Cradle Control Panel”

class=“com.windriver.ws.emulator.cradle.

CradleControlPanel”

type=“SYSTEM”>

</pluginDescriptor>
<publicLibraryDescriptor name=“Emulated Cradle Driver”

specificationVersion=“1.0.0”>

<export>

<class>com.windriver.ws.emulator.cradle.CradleDriverEmul</class>
<class>com.windriver.ws.emulator.cradle.

CradleControlPanel</class>

</export>
</publicLibraryDescriptor>

</archive>
</definition>

As described above, each of the emulated drivers 18′ may optionally have a GUI 31 associated therewith to allow developers to monitor the state and behavior of the emulated driver 18′. The GUI 31 extends the abstract class EmulatorControlPanel which is an implementation of the ServicePlugin interface. Therefore, an extension of the EmulatorControlPanel is also a service plug-in. The EmulatorControlPanel class contains the abstract method getContainer(). The implementation of the method getContainer() enables the JNI simulation module 28 to add the control panel to the application window. In this example, the method must return a java.awt.Panel or a javax.swing.JPanel. The preferred container is JPanel as the exemplary JNI Simulation module 28 is described as being implemented in Swing. The control panel acquires a reference to the emulated driver 18′ with which it is to work using the PluginContext. The control panel then provides the emulated driver 18′ with a reference to itself by calling the method setControlPanel(EmulatorControlPanel), which every Emulated Driver will implement.

To continue with the above example, the control panel code for the cradle driver may include the following lines:

package com.windriver.ws.emulator.cradle;
// NOTE: same package name as the emulated cradle driver
import com.windriver.ws.core.plugin.*;
import com.windriver.ws.emulator.controlmanager.EmulatorControlPanel;
import java.awt.event.*;
import javax.swing.*;
/**
* The control panel for the emulated Cradle Driver - provides the ability
* to send state changes to the driver.
*/
public class CradleControlPanel extends EmulatorControlPanel {

private PlugContext m_context;
private JPanel m_container;
private EmulatedCradleDriver m_driver
/**
* Contrsuctor.
*/
public CradleControlPanel () {
}
/**
* Overrides the init method found in EmulatorControlPanel - creates
* the GUI portion of the control panel, acquires a reference to the
* emulated cradle driver and registers this control panel with the driver
*/
public void init() {

m_container = new CradleGUI (this);
try {

PluginQuery query = new PluginQuery(“Emulated Cradle Driver”);
PluginDescriptor pd[] (PluginDescriptor[])

m_context.find(query,PluginDescripto.class);

if(pd.length > 0) {
}

}
catch(Exception e) {

System.err.println(“CradleControlPanel-” +e.getMessage());
}

}

/**
* Implementation of abstract method found in EmulatorControlPanel -
* provides access to the GUI portion of the control panel.
* @return The GUI panel
*/
public Container getContainer() {
return m_container;

}
/**
* The name of this control panel, so that it may be identified in the control viewer
*/
public String getName() {

return “Cradle”;

}
// the next two methods are only called by the CradleGUI object, so that
// the proper cradle state can be reflected to the user
public boolean inCradle() {

return M_driver.inCradle();

}
public.void setInCradle(boolean p_bolInCradle) {

m_driver.setInCradle(p_bolInCradle);

}
}
// GUI Code - a panel with two buttons, one to place the device in cradle,
// one to take the device out
class CradleContainer extends JPanel implements ActionListener {

CradleControlPanel m_control;
public CradleContainer(CradleControlPanel p_control) {

m_control = p_control;
// create the GUI here
. . .

}
public void actionPerformed(ActionEvent evt) {

if (evt.getActionCommand().equals(“IN CRADLE”)){

m_control.setInCradle(true);

return;

} else {
if (evt.getActionCommand().equals(“OUT OF CRADLE”)){

m_control.setInCradle(false);
}

}

}

}

Applications interact with drivers using a service plug-in that provides a convenient API 23 for use of the driver. The service plug-in must reference a Java class that implements the driver interface 36 whether the Java class is a JNI class of a native driver 34 or an emulated driver class 18′. For example, as described above, the service plug-in operates by obtaining a reference to either the native driver 34 or the emulated driver 18′ by providing the driver locator 18″ with the fully qualified class names of the driver interface 36 and the JNI class 38 corresponding to the driver 34 and the emulated driver 18′. The driver locator 18″ first attempts to return an emulated driver 18′ implementing the specified driver interface 36. If this attempt is not successful, the driver locator 18″ attempts to load the corresponding JNI class from the class path. In either case, the service plug-in receiver an object that implements the driver interface 36, or null if no such driver is found.

A cradle driver as described above may, for example, be loaded as follows:

private static final String CRADLE_DRIVER_INT =

“com.windriver.ws.corex.cradle.CradleDriverInterface”;

. . .
public void init () {

try {

// get the JNI class name property from theis plugins descriptor

PluginDescriptor pd_this = m_context.getPluginDescriptor ();
String strJNIClassname = pd_this.getProperty(“JNI classname”, null);
// load the driver locator plugin
PluginQuery query = new PluginQuery (“Driver Locator”);
PluginDescriptor pd[] = (PluginDescriptor []) m_context.find

(query, PluginDescriptor.class);

DriverLocator dl = null;
if (pd.length > 0) {

dl = (DriverLocator) m_context.getPlugin(pd[0]);

// using the driver locator plugin, load the cradle driver
CradleDriver cradleDriver = (CradleDriverInterface)
dl.getDriver(CRADLE_DRIVER_INTERFACE, strJNIClassname);
}

In this example, the JNI class name may preferably be loaded from the mainifest file through the plug-in context as a property in the plug-in descriptor as this may allow developers to switch versions of the JNI class more easily.

An example of the declaration of a property in the driver service plug-in manifest file in accord with the above example is as follows:

<archive name=“Cradle Service”>

<pluginDescriptor name=“Cradle Service”

class=“com.windriver.ws.corex.cradle.CradleServiceImpl”
type=“SERVICE”>

<property name=“JNI_CLASSNAME”>com.windriver.ws.corex.cradle.

CradleServiceImpl</property>

</pluginDescriptor>
<publicLibraryDescriptor name=“Cradle”

specificationVersion=“1.1.0”>

<export>

<class>com.windriver.ws.corex.cradle.CradlePlugin</class>
<class>com.windriver.ws.corex.cradle.CradleDriverInterface</class>

</export>

</publicLibraryDescriptor>

</archive>

The developer then adds the driver plug-in 18′ and the GUI 31 to the load file to create the emulated load. In the example above, this may be done as follows:

<project name=“emulator”>

<! required plugins - ->
<archive> controlmanager </archive>
<archive> swing
<archive> frame
<archive> skins
<archive> stormpadskin
<archive> stormpadimages </archive>
<!emulated services - ->
<archive> cradle </archive>

</project>

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method of developing a device application for interacting with an outside application including the steps of:
installing a first driver module, the first driver module being one of a first native driver to operate on the device and an emulation of the first native driver;
installing a first interface module for managing communication between the first driver module and the outside application, wherein the first interface module is configured to operate with both the first native driver and the emulation of the first native driver; and
installing a driver locator module which, upon receipt of a communication from the outside application, locates one of a native driver to which the communication corresponds and an emulation thereof.

2. The method according to claim 1, wherein the outside application is a Java application.

3. The method according to claim 1, wherein the steps are performed on a work station and wherein the device application is for an embedded device.

4. The method according to claim 1, further comprising the steps of:
installing a second driver module, the second driver module being one of a second native driver to operate on the device and an emulation of the second native driver;
installing a second interface module for managing communication between the second driver module and the outside application, wherein the second interface module is configured to operate with both the second native driver and the emulation of the second native driver.

5. The method according to claim 1, further comprising the step of utilizing a graphical interface on a work station to simulate interaction with the device application via device hardware.

6. A software package for developing a device application for interacting with an outside application comprising:
a first driver module being one of a first native driver to operate on the device and an emulation of the first native driver;
a first interface module for managing communication between the first driver module and the outside application, wherein the first interface module is configured to operate with both the first native driver and the emulation of the first native driver; and
a driver locator module which, upon receipt of a communication from the outside application, locates one of a native driver to which the communication corresponds and an emulation thereof.

7. The software package according to claim 6, wherein the outside application is a Java application.

8. The software package according to claim 6, wherein the software package operates on a work station and wherein the device application is for an embedded device.

9. The software package according to claim 6, further comprising:
a second driver module being one of a second native driver to operate on the device and an emulation of the second native driver;
a second interface module for managing communication between the second driver module and the outside application, wherein the second interface module is configured to operate with both the second native driver and the emulation of the second native driver.

10. The software package according to claim 6, further comprising a graphical interface to simulate on a workstation interaction with the device application via device hardware.

11. A software package for developing on a workstation an application for interaction between an embedded device and an outside application comprising:
first and second driver modules, each of the first and second driver modules being one of a native driver to operate on the device and an emulation of the native driver;
first and second interface modules for managing communication between the outside application and the first and second driver modules, respectively, wherein the first and second interface modules are configured to operate with both native drivers and emulations thereof;
a driver locator module which, upon receipt of a communication from the outside application, locates one of a native driver to which the communication corresponds and an emulation thereof; and
a graphical interface module simulating interaction between outside application and the first and second driver modules via the embedded device hardware.

12. A software development system, comprising:
a host development platform having at least one software development tool;
a connection between the host development platform and a target system including a target operating environment, the target operating environment having a driver interface corresponding to an actual device driver;
a device simulator system including:
an emulated device driver accessed by the target system via the connection when the actual device driver is not present in the target system.

13. The software development system according to claim 12, wherein the host development platform includes a target agent accessible to the at least one software development tool and coupled to the connection.

14. The software development system according to claim 12, wherein the connection includes a TCP/IP link to the target system.

15. The software development system according to claim 12, wherein the device simulator system further includes an emulator interface corresponding to the simulated device driver.

16. A software development system, comprising:
a host development platform having at least one software development tool for developing a software application for a target system having a driver interface corresponding to an actual device driver to be used in the target system;
a device simulator system including an emulated device driver accessed when the actual device driver is not present.

17. A software development system, comprising:
a target operating environment, including:
a device driver interface corresponding to an actual device driver; and
a driver locator module; and
a device simulator, including an emulated device driver adapted for operation with the device driver interface, wherein the driver locator directs access via the device driver interface to the emulated device driver when the actual device driver is not present in the target operating environment.

18. The software development system according to claim 17, the device simulator further including an emulation user interface corresponding to the simulated device driver and wherein the emulation user interface is displayed during access of the emulated device driver.

19. The software development system according to claim 17, wherein the target operating system is located on a target hardware platform and the device simulator is located on a host development platform.

20. The software development system according to claim 17, wherein the wherein the target system environment and the device simulator are located on a host development platform.

21. The software development system according to claim 17, the target operating environment further including a core module, the core module executing the device locator module upon an access via the device driver interface.

22. The software development system according to claim 17, the target operating environment further including a Java Native Interface module and a Java Native Interface class corresponding to the actual device driver.
